(19) United States
(12) Patent Application Publication
(10) Pub. No.: US 2011/0137526 A1
(43) Pub. Date: Jun. 9, 2011

(54) STEERING SYSTEM AND CONTROL METHOD FOR THE SAME

(75) Inventor: Jae Hyung Kim, Seongnam-si (KR)

(73) Assignees: Hyundai Motor Company, Seoul (KR); Kia Motors Corporation, Seoul (KR)

(21) Appl. No.: 12/862,433

(22) Filed: Aug. 24, 2010

(30) Foreign Application Priority Data
Dec. 4, 2009 (KR) 10-2009-0120127

(51) Int. Cl. G06F 19/00; B62D 5/04

(52) U.S. Cl. 701/44

(57) ABSTRACT

A steering system includes a sport mode select/release switch, a steering control portion which changes steering mode stored in a steering mode map in response to signal from the sport mode select/release switch and an electro mechanical steering device controlled by the steering mode of the steering control portion.

### CROSS-REFERENCE TO RELATED APPLICATION

The present application claims priority to Korean Patent Application No. 10-2009-0120127 filed in the Korean Intellectual Property Office on Dec. 4, 2009, the entire contents of which are incorporated herein by reference.

### BACKGROUND OF THE INVENTION

1. Field of the Invention

The present invention relates to a steering system and control method for the same. More particularly, the present invention relates to a steering system operated in response to shift mode and control method for the same.

2. Description of Related Art

Recently, an automatic transmission is provided with a sport mode so as to provide a driver's deeper control and a dynamical shift feel. When such a sport mode is selected by moving a shift lever to a manual gate (or called a sport mode gate), only shifting characteristics are changed.

When shift lever is changed to sport mode and a driver intends to frequent change lane, however, steering characteristic is tuned to a general characteristic so that sport deriving performance is not realized sufficiently.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a steering system and control method for the same having advantages that steering characteristic is also changed in response to shift mode change.

In an aspect of the present invention, the steering system may include a sport mode select/release switch, a steering control portion changing steering mode stored in a steering mode map in response to a signal received from the sport mode select/release switch, and an electro mechanical steering device controlled in accordance with the changed steering mode of the steering control portion.

The electro mechanical steering device may receive a signal of a steering wheel to generate torque and changes the torque according to the changed steering mode of the steering control portion.

The electro mechanical steering device may send a control signal to a transmission control unit to control an automatic transmission as a sport mode when the steering control portion receives a signal of the sport mode select/release switch to activate the sport mode.

The electro mechanical steering device may be a MDPS (Motor driving power steering) or an EHPS (Electric-Hydraulic power steering).

The steering mode map may store a general deriving mode and a sport mode, wherein the sport mode outputs more powerful repulsive power signal than repulsive power signal of the general deriving mode, and wherein the sport mode outputs more amplified steering angle signal than steering angle signal of the general deriving mode.

The sport mode select/release switch and the steering control portion may communicate with each other through a CAN network.

The sport mode select/release switch may be a select/release lever of a shift lever.

In another aspect of the present invention, the steering system control method may include detecting mode signal of sport mode select/release, changing shift mode in response to the detected mode signal, changing steering mode stored in a steering mode map in response to the detected mode signal, and controlling an electro mechanical steering device according to the changed steering mode.

The steering system control method may further include activating an electro mechanical steering device which generates torque to change the torque according to the changed steering mode.

The steering system control method may further include controlling a transmission control unit to control an automatic transmission as a sport mode according to the changed steering mode.

As described above, a steering system and the control method for the same according to an exemplary embodiment of the present invention may change steering characteristic in response to shift mode change so that active control of steering is possible.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram of a steering system according to and exemplary embodiment of the present invention.

FIG. 2 is a flow chart showing a method for the steering system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

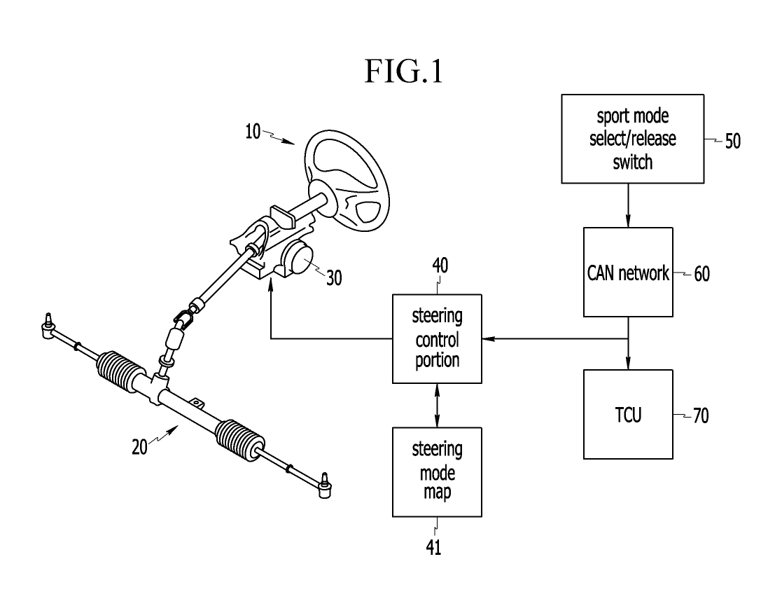

FIG. 1 is a schematic diagram of a steering system according to an exemplary embodiment of the present invention.

Referring to FIG. 1, a steering system according to an exemplary embodiment of the present invention includes a sport mode select/release switch 50, a steering control portion 40 which changes steering mode stored in a steering mode map 41 in response to signal from the sport mode select/release switch 50 and an electro mechanical steering device 30 controlled by the steering mode of the steering control portion 40.

The sport mode select/release switch 50 may be a select/release lever of a shift lever. That is, the sport mode select/release switch 50 may be a separate switch equipped in a passenger compartment. Or when a sport mode is selected by moving the shift lever to a manual gate (or called a sport mode gate), the steering control portion 40 may output sport mode steering signal according to the steering mode stored in the steering mode map 41, vise versa.

The electro mechanical steering device 30 may be one of a MDPS (Motor driving power steering) or an EHPS (Electric-Hydraulic power steering) and the electro mechanical steering device 30 receives signals of steering wheel 10, which is controlled by a driver, and operates a gear box 20 according to the signals of steering wheel 10.

When a driver turns on the sport mode of the sport mode select/release switch 50 and controls the steering wheel 10, the electro mechanical steering device 30 generates torque for the driver to feel heavy or light, and controls the gear box 20 for a vehicle to drive according to driver's intention.

The steering mode map 41 stores a general deriving mode and a sport mode, wherein the sport mode outputs more powerful repulsive power signal than repulsive power signal of the general deriving mode, and the sport mode outputs more amplified steering angle signal than steering angle signal of the general deriving mode.

That is, when a driver selects the sport mode, the driver feels heavy in operating the steering wheel 10. Simultaneously when the driver controls the steering 10, front wheels (not shown) responses fast and steering angle may be more increased so that sport characteristic (handling) may be realized.

Simultaneously a TCU (transmission control unit) 70) controls an automatic transmission as the sport mode in accordance with a control signal of the steering control portion 40.

The sport mode select/release switch 50 and the steering control portion 40 may communicate with each other through a CAN network 60.

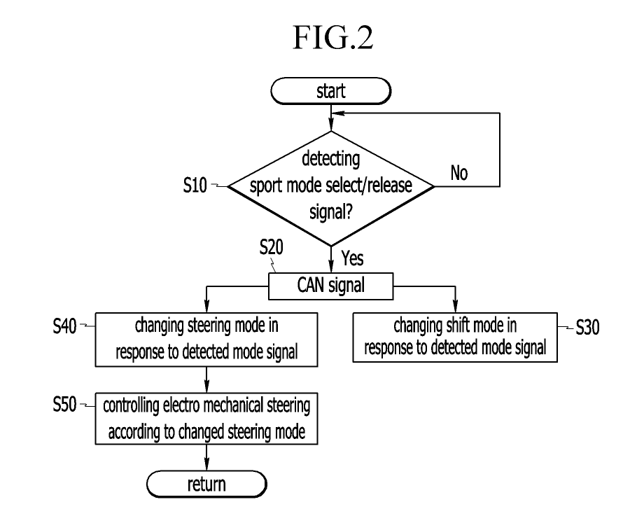

FIG. 2 is a flow chart showing a method for the steering system according to an exemplary embodiment of the present invention.

A steering system control method according to an exemplary embodiment of the present invention includes detecting sport mode select/release signal (S10), changing shift mode in response to the detected mode signal (S30), changing steering mode stored in a steering mode map in response to the detected mode signal (S40) and controlling an electro mechanical steering device according to the changed steering mode (S50).

The sport mode select/release switch 50 and the steering control portion 40 communicates with each other through a CAN network (S20). The steering control portion 40 receives the CAN signal (S20), changes steering mode according to the signal and controls the electro mechanical steering device 30 (S50).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A steering system comprises:
a sport mode select/release switch;
a steering control portion changing steering mode stored in a steering mode map in response to a signal received from the sport mode select/release switch; and
an electro mechanical steering device controlled in accordance with the changed steering mode of the steering control portion.

2. The steering system of claim 1, wherein the electro mechanical steering device receives a signal of a steering wheel to generate torque and changes the torque according to the changed steering mode of the steering control portion.

3. The steering system of claim 1, wherein the electro mechanical steering device sends a control signal to a transmission control unit to control an automatic transmission as a sport mode when the steering control portion receives a signal of the sport mode select/release switch to activate the sport mode.

4. The steering system of claim 1, wherein the electro mechanical steering device is a MDPS (Motor driving power steering) or an EHPS (Electric-Hydraulic power steering).

5. The steering system of claim 1, wherein the steering mode map stores a general deriving mode and a sport mode,
wherein the sport mode outputs more powerful repulsive power signal than repulsive power signal of the general deriving mode, and
wherein the sport mode outputs more amplified steering angle signal than steering angle signal of the general deriving mode.

6. The steering system of claim 1, wherein the sport mode select/release switch and the steering control portion communicate with each other through a CAN network.

7. The steering system of claim 1, wherein the sport mode select/release switch is a select/release lever of a shift lever.

8. A steering system control method comprising:
detecting mode signal of sport mode select/release;
changing shift mode in response to the detected mode signal;
changing steering mode stored in a steering mode map in response to the detected mode signal; and
controlling an electro mechanical steering device according to the changed steering mode.

9. The steering system control method of claim 8, further comprising:
activating an electro mechanical steering device which generates torque to change the torque according to the changed steering mode.

10. The steering system control method of claim 8, further comprising:
controlling a transmission control unit to control an automatic transmission as a sport mode according to the changed steering mode.

11. The steering system control method of claim 8, wherein the electro mechanical steering device is a MDPS (Motor driving power steering) or an EHPS (Electric-Hydraulic power steering).

12. The steering system control method of claim 8, wherein the steering mode map stores a general deriving mode and a sport mode,
wherein the sport mode outputs more powerful repulsive power signal than repulsive power signal of the general deriving mode, and
wherein the sport mode outputs more amplified steering angle signal than steering angle signal of the general deriving mode.
